(19) United States
(12) Patent Application Publication
(10) Pub. No.: US 2012/0178895 A1
(43) Pub. Date: Jul. 12, 2012

(54) METHOD AND DEVICE FOR THE PRODUCTION OF A SPRAY APPLICATION CONSISTING OF REACTIVE PLASTIC

(75) Inventors: Hans-Guido Wirtz, Leverkusen (DE); Stephan Schleiermacher, Pulheim (DE); Roger Scholz, Doenrade (NL); Frithjof Hannig, Dusseldorf (DE); Dirk Steinmeister, Leverkusen (DE); Frank Grimberg, Dormagen (DE); Andreas Frahm, Leverkusen (DE)

(73) Assignee: Bayer MaterialScience AG, Leverkusen (DE)

(21) Appl. No.: 13/392,012

(22) PCT Filed: Aug. 13, 2010
(86) PCT No.: PCT/EP2010/004964

§ 371 Date: Mar. 27, 2012

(30) Foreign Application Priority Data
Aug. 26, 2009 (DE) 10 2009 038 868.0

(51) Int. Cl. C08G 18/32; B01F 13/02

(52) U.S. Cl. 528/85; 366/101

(57) ABSTRACT

The present invention relates to a method for the production of layers and moulded parts consisting of reactive plastic, the reactive components being intermixed on a plurality of planes with the aid of mixed gases. The invention further relates to a device which allows a corresponding method.

The present invention relates to a process for producing layers and molded parts of a reactive plastic material, wherein the reactive components are mixed with each other in a spray channel in several planes by means of mixing gases. The invention further relates to a device by which such a process is enabled.

The use of different reactive plastic materials for producing molded parts is well known from the prior art. When it comes to applying a reactive plastic material to a substrate, spraying has mostly been the application technique of choice. Polyurethanes are often used as reactive plastic materials, but the techniques described are also applicable to other reactive plastic materials.

In the Kunststoffhandbuch, Volume 7, Polyurethane, Carl Hanser Verlag, various application examples of such spraying techniques are described.

In the polyurethane processing, the mixing of the liquid reaction components is effected in a mixing head, wherein a distinction can be made between high pressure and low pressure mixing. In both cases, the spray application is realized by downstream atomizer systems.

In the low pressure mixing method, the mixing energy necessary for mixing the reaction components is introduced by dynamic agitators or static mixing elements. The volumes of the mixing chambers are relatively large as compared to mixing heads used in high pressure mixing and must be cleaned by suitable detergents or compressed air after completion of the mixing process. In particular, when highly reactive polyurethane systems are processed, such low pressure mixing heads have a design-related tendency to accumulate mixing chamber deposits and thus to clog after extended periods of operation.

In the high pressure mixing method, the pressure energy of the reaction components is converted to kinetic energy by nozzles. By injecting the components from nozzles into a comparatively small mixing chamber, the kinetic energy is concentrated in space and utilized for mixing. The cleaning of the mixing chamber is effected by mechanical plungers, so that short-term interruptions of the spraying process are possible. This advantage is a feature of high pressure mixing heads that is critical for the formation of constant layer thicknesses in robot-guided spraying processes, since the moving speeds are reduced immediately before the turning points of the robot paths, thus changing the ratio of surface area to material output. The possibility of a brief interruption of the spraying application enables the turning points to be shifted to the outer regions of the areas to be sprayed.

The atomizer systems downstream of the mixing process serve to divide the reaction mixture into individual droplets. Single nozzles (airless high pressure atomization) and dual nozzles with external and internal mixing (pressure atomization) are employed for the atomization. The advantage of dual nozzles with internal mixing is their having relatively large cross-sectional areas of flow, so that liquids containing coarse particles can also be sprayed. Another advantage is the fact that changes in viscosity or volume flow have less impact on the geometry of the spray jet. This property is of great importance to the processing of solids-laden polyurethane systems by the process described below, since the possibility to variably adjust the solids proportions leads to great changes in viscosity.

Different atomizer systems are also described in the prior art. For example, corresponding air and/or gas inlet openings in the flow channel are known from U.S. Pat. No. 3,923,253, DE 10 2007 016 785 A1, or U.S. Pat. No. 6,131,823.

A device in which reactants are optionally guided into a mixing tube from two feed conduits is known from DE 27 00 488 A1. The mixing tube has a number of nozzles B1, D1, B2 and D2, through which a high-pressure medium, for example, a gas, but also components of the main liquid stream are introduced into the tube, and mixed with the main liquid stream. The nozzles are mounted in opposition to each other, so that turbulence occurs in the mixing tube.

However, for many applications, it is necessary to admix additional components with the reactive plastic material. On the one hand, these may be fibers, which enable a higher stability of the product. Other possible additives include fire retardants, antioxidants, UV protection agents and the like. The admixing of solid, liquid and/or gaseous components with the reaction mixture is described in different ways in the prior art. In WO 03/037528 A2, the polyol and isocyanate components are mixed together with a filler in a mixing head. This enables the mixing of the polyurethane components not only with one another, but also with the filler. However, there is a drawback in that the mixing head can be damaged by the filler. Also, the fillers themselves can be damaged by shear forces that may occur in the mixing head.

Alternatively, such an additive may also be added to the reaction mixture after the mixing. This is frequently done by mixing the spray jet of the reactive plastic material with a spray jet of the corresponding filler. This is known, for example, from DE 25 17 864 A1, U.S. Pat. No. 3,302,891, WO 2009/052990 A1, or EP 1 458 494 B1. In the processes described therein, the mixing head is no longer damaged by the fillers. Also, there is no damage to the fillers themselves. However, the wetting of the fillers with the reaction mixture is often insufficient.

The as yet unpublished patent application PCT/EP 2009/001007 describes a newly developed process for introducing solids into a polyurethane spray jet atomized by pressurized gas. The introduction of the solids particles is effected by means of a spray gas as a particle carrier into the liquid reaction mixture that is still contained in the spray attachment (reaction jet). A device by which such a process is enabled is described, for example, in the as yet unpublished PCT application PCT/EP 2009/003545. Through an attachment with an integrated mixing plane downstream of the mixing head, the gas/solids mixture is supplied tangentially to the liquid reaction mixture, mixed by means of the resulting rotational twist, and only thereafter, it is discharged as a multiphase mixture through an atomizer as a spray jet.

Before this process was developed, the supplying and admixing of solids through the gas stream supply of dual nozzles with internal mixing was not provided for in polyurethane spraying processes. The spraying devices merely had the function of a pressure atomizer, wherein short dwelling times of the reaction mixtures in the spray attachment as well as barrier-free channel geometries without dead space are preferred for reasons of clean-keeping.

However, in experiments performed by the process described in PCT/EP 2009/001007 using the spraying device described therein, it was noted that the wetting of the particles may be insufficient in part when higher solids contents are processed.

High solids contents with small particle sizes offer a large surface area to the reaction mixture, which cannot be sufficiently mixed and wetted with the reaction mixture because of the short dwelling time in the mixing zone. In addition, solid particles with a high density will accumulate in the wall zone of the flow channel because of centrifugal forces, and can be mixed with the reaction mixture only conditionally because of the densification. For a mixture output of, for example, 100 g/s and a solids content of 70% by weight (barium sulfate), this effect was seen as an annular structure of unwetted solids particles when the mixture was discharged.

Another indication of insufficient mixing, for example, the local accumulation of solids by centrifugal forces, is swirling erosions at the walls of the flow channel. When the flow is turbulent and the solids particles are homogeneously distributed, a uniform surface wear should be observed when an uncured spray attachment is used.

Therefore, it is an object of the present invention to develop a process and a device for producing layers and molded parts of a reactive plastic material, especially polyurethane, especially by spray application, by which higher solids contents can be processed, wherein a uniform wetting of these solids is ensured at the same time.

As known from DE 10 2005 058 292 A1, a lightweight and small design is advantageous for a spraying process using robots. Robot-guided mixing heads involve extremely rapid changes of movement; for manually guided mixing heads, the advantage of a lightweight and small design is self-explanatory. Therefore, it is a further object of the present invention to provide a device that is small and has a lightweight design. Using such a device, it should be possible to introduce a high solids content into the reaction mixture. Further, it should be wear-resistant, have spraying capability, and be easily cleaned. In particular, a device according to the invention enables short application intervals; in addition, it can be adapted to commercially available casting/mixing heads.

The object of the invention could be achieved by a process in which the mixing section has been extended, and several mixing planes introduced therein.

In a first embodiment, a reaction mixture, especially a polyurethane reaction mixture, was passed from a mixing head into a device according to the invention. A solids/gas mixture was added through inlets. The individual mixing planes consist of at least one gas channel through which the gas stream flows, leading into the spray channel. According to the invention, the direction of flow of the gas stream when entering the spray channel runs outside the center of the spray channel. The tangential arrangement provides the axial flow with a radial flow component. Because of this radial flow component, the components, i.e., the reaction mixture and the solid in this case, are intensively mixed together. The gas channels and the inlet openings in the respective mixing planes are arranged in such a way that opposing twist directions are impressed on the mixture over the course of the flow. The twist direction of one plane is opposed to the twist direction of the following mixing plane. The first mixing plane, i.e., the first at least one gas channel, is above the inlet openings for the solids-gas mixture.

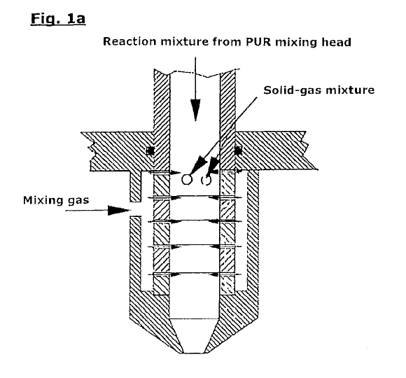

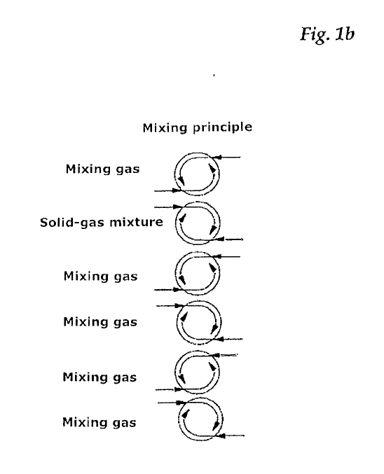

FIG. 1a shows a cross-sectional view of a device according to the invention. For the sake of a simplified functional representation, the mixing gas channels leading into the mixing space are not drawn in a tangential direction in this and also in the following sectional drawings.

FIG 1b shows the mixing principle in a device according to the invention. In a nozzle according to the invention, a radial flow component is impressed by the mixing gas in the spray channel in which the reaction mixture flows axially. This causes again turbulence of the reaction mixture. In a next mixing plane, the solids-gas mixture is introduced through appropriate inlets. The inlet channels are also tangentially arranged, so that a further mixing takes place here. The twist direction caused by the solids-gas mixture is opposed to the twist direction caused by the mixing gas in a first mixing plane. In a further mixing plane, a mixing gas is now again injected through appropriate gas channels.

Here, the tangential injection again causes a radial disturbance of the axial flow of the reaction mixture. The twist direction of the reaction mixture produced here is again opposed to the twist direction produced by the introduced solids/gas mixture. A good performance of mixing between the solid and the reaction mixture is ensured by the opposing twist directions. The reaction mixture itself is also thoroughly mixed. For this purpose, it is critical that a gas inlet for the mixing gas is provided upstream of the inlets for the solids/gas mixture. Therefore, a device according to the invention has at least one gas inlet in each of at least two planes, namely one upstream of the inlets for the solids/gas mixture, for example, and one downstream of these inlets.

According to the invention, not only a solids-gas mixture can be introduced into the reactive stream through the inlets. It is also possible to introduce the individual components of the reaction mixture through them. It is further possible to admix solid, liquid and/or gaseous additions to the reaction mixture. However, it is always to be considered that there is a mixing plane upstream of these inlet openings, i.e., that a mixing gas is injected into the flow channel.

Preferably, a device according to the invention has further mixing planes. As shown in FIG. 1b, the respective at least one gas inlet in said further mixing planes is arranged in such a way that the twist direction initiated by the mixing gas is different from, namely opposed to, that of the mixing plane immediately above. In particular, a device according to the invention has more than two, especially more than four, especially more than 6, mixing planes with at least one gas inlet.

Thus, the vectors of the gas streams serve the function of a static mixer or agitator. According to the invention, each mixing plane has at least one, especially two, gas inlets.

Surprisingly, experiments with a device according to the invention have shown that the opposing twist directions in the mixing channel and the highly pronounced shear forces produce a mixing effect that is qualitatively so good that mixing the reaction components by an upstream PUR mixing head can be dispensed with.

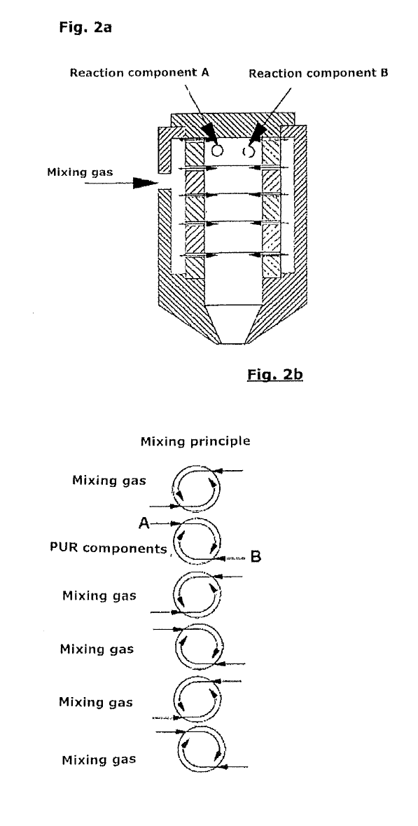

FIG. 2a shows a modular mixer design according to the invention without an upstream PUR mixing head, in which the mixing planes can be combined according to need depending on the required mixing performance by, for example, mixing elements in disk form. The original inlet bores are used here for introducing reaction components A and B of the reactive plastic material. FIG. 2b shows the corresponding mixing principle. Two inlet openings are shown here. However, further inlet openings can be provided in the same plane according to the invention.

Thus, in a process according to the invention, at least 2 components are introduced into the spray channel in a nozzle individually through said at least two inlets from the outside, where they are mixed. This spray channel has at least two mixing planes into which at least one mixing gas is injected through at least one tangentially arranged gas channel, and at least one of these mixing planes is provided upstream of the inlets for the components, and the other downstream thereof. “Upstream” and “downstream” are to be understood in accordance with the direction of flow of the reactive stream.

Thus, the mixing head function is served exclusively by the device according to the invention, the mixing/spraying nozzle, whereby very small and lightweight designs without moving parts and seals can be realized at low cost. Further, cost-intensive high-pressure metering systems can be dispensed with according to the invention.

In a device according to the invention, the spray channel is inside the mixing nozzle. It is separated by a wall from a gas space surrounding it, wherein a mixing gas can be injected into the spray channel from the gas space into the spray channel in at least two mixing planes through at least one gas channel each. Thus, only one gas connecting port for the nozzle according to the invention is required. The mixing gas flows with the same pressure through all existing gas channels into the interior of the spray channel. Within one plane, there is at least one gas channel that passes the mixing gas from the gas space into the spray channel. Preferably, however, more than one gas channel is in one plane, and preferably, two gas channels that are opposed to one another are in one plane.

In a preferred embodiment, the cylindrical mixing zone has a tapering nozzle outlet. Such a design is the simplest design of a spray-mixing nozzle according to the invention.

The principle of pressure mixing produces a gas load of the mixture, which causes a reduction in density of the later polyurethane matrix and is undesirable for certain applications. For example, in functional layers for sound reduction according to the spring-mass principle, densities in the mass layer of clearly >2 are sought. In such a case, the addition of solids with a simultaneous gas load brought about by the mixing process would be counterproductive.

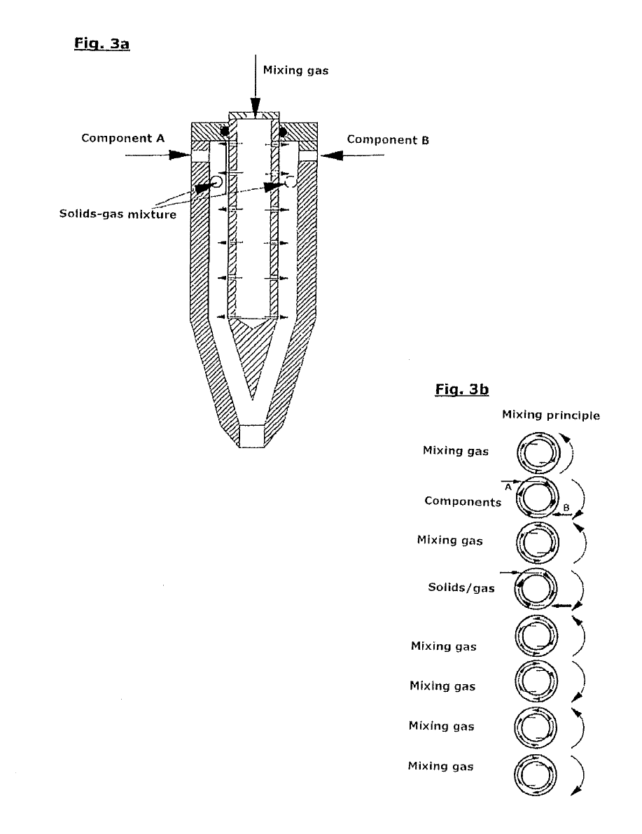

Therefore, in a further embodiment, the object of the present invention is achieved by a spray-mixing nozzle in which a hollow cylinder is provided in the interior of the spray channel, in the center of which hollow cylinder a gas distributor is provided through which mixing gas streams are injected tangentially through gas channels leading into the spray channel. FIG. 3a shows a cross-sectional view of a device according to the invention. FIG. 3b shows the related mixing principle. The injected streams of mixing gas are injected tangentially and respectively opposed to one another. In the spray channel, which is now on the outside, corresponding reactive components, but also solid, liquid and/or gaseous additives can be introduced from the outside. The inlets for the reactive components and additives are provided on two different planes, the reactive components being introduced in one plane, and the additives in a different plane. Between these planes, there is at least one mixing plane into which a mixing gas is injected.

Such a mixing space geometry ensures the mixing between the individual reactive components and the additives, especially solids. The flowing out of the gas from the inside to the outside enables sufficient mixing even when the amount of pressurized gas is reduced and the gas load is thus reduced. The mixing is enabled by opposing, tangentially injected mixing gases and thus by opposing twist directions in the individual mixing planes. The introduction of the reactive components and the additive is also effected in such a way that the twist direction is changed within the nozzle.

The geometry of the mixing space consists of a hollow cylinder in the center of which there is a gas distributor. Because of the formation of an annular flow with a small clearance, it can be excluded that the mixing effect of the pressurized gas streams is lost in the center of the mixing space (in the center of the flow channel), in contrast to a cylindrical mixing space. Further, the mixing effect of the gas flows is not adversely affected by centrifugal forces either.

In the arrangement described in FIG. 3a, the clean-keeping of the pressurized gas channels is advantageous because the mixing chamber wall bounding towards the outside is absolutely closed after the solids have been supplied, and thus the entry of wetted solid particles into the gas channels by centrifugal forces can be excluded. In a corresponding gas flow, the entry of the mixture into the mixing gas channels by backflow is not possible.

In a corresponding design, the position of the gas distributor provided in the center can be shifted axially, whereby the volume and thus the flow rate in the mixing space directly before the outlet opening can be adjusted. This effect can be used for influencing the spray image, among other things.

A spray-mixing nozzle as described in FIG. 3a can also be combined with conventional PUR mixing plants if needed, and thus enables the continued use of existing machine technology.

The cleaning of a spray-mixing nozzle according to the invention can be effected by pressurized gas according to the prior art. The cleaning process is initiated by switching off the component streams and maintaining or increasing the supply of pressurized gas. This procedure also enables short-term shot interruptions by analogy with the high-pressure technology, which is advantageous, for example, in robot-guided spray application for the formation of a uniform thickness of spray layers, as mentioned above.

In a particular embodiment, the entry angles of the gas channels were arranged below the component plane tangentially and obliquely in the direction of the component flow, whereby the mixing effect is again increased. However, this entry geometry of the gas streams is possible only by using increased gas flow rates or a high flow velocity, because the tilt in the direction of flow of the mixture favors the entry of the mixture into the gas channels.

In addition to the number of mixing planes, the gas flow rate, the direction of rotation and the entry angle of the gas streams, an influence on the mixing process may also be exerted by pulsating gas streams. In a pulsating gas supply, it is advantageous if the respective mixing planes are supplied with high frequency pulses of pressurized gas independently and optionally alternately. The pressurized gas supply of the devices from FIG. 1a and FIG. 2a, which is present on the outside, offer ideal conditions for this process variant.

Not only solids-gas mixtures can be introduced into a reaction mixture by means of a device according to the invention. It is also possible to introduce reaction components as preatomized aerosols into the nozzle using a pressurized gas stream. Mass differences in the mixing ratio of the reaction partners can be compensated by adapting the volume flows and the particle sizes. For example, mixing ratios of up to 100 to 1, which usually cannot be mixed by high-pressure mixers, can be mixed or processed successfully up to an application speed of 50 g/s.

In another embodiment, it is additionally possible to inject hot gas into the reaction mixture through the existing inlets. This enables the thermal activation of the reactants. Because of the short mixture dwelling times, gas temperatures of up to 600° C. are employed in a process according to the invention.

Influencing the courses of the reaction of reactive plastic materials through heated mold surfaces or temperature-controlled mixture components is a usual procedure. The process of hot-air spraying enables similar effects, but which can be varied over the duration of the discharge of the mixture if needed. Thus, it is possible to adapt the course of the reaction of the mixture over the entire duration of spraying, for example, for large area components, whereby the productivity of such processes can be enhanced. In addition, the distribution of reaction mixtures on slant surfaces can also be influenced positively.

According to the invention, the reactive plastic material is preferably polyurethane. Therefore, the reactive components employed are polyol and isocyanate components, in particular. Components that are well known from the prior art can be used.

According to the invention, fibers are preferably introduced into the reaction mixture through the inlets. Other possible solids that may be added include, for example, flame retardants, stabilizers or antioxidants. The same functions may also be served by the liquid auxiliaries that may be supplied.

1. A process for producing layers and molded parts of reactive plastic materials, characterized in that at least two components are introduced into a spray channel of a nozzle individually through inlets from the outside, where they are mixed, wherein said spray channel has at least two mixing planes into which at least one mixing gas is injected through at least one tangentially arranged gas channel, and at least one of these mixing planes is provided upstream of the inlets for the components.

2. The process according to claim 1, characterized in that the mixing gas is injected into the spray channel in such a way that the direction of flow of the gas stream when entering the spray channel runs outside the center of the spray channel.

3. The process according to claim 1, characterized in that a polyol and an isocyanate component are introduced into the nozzle.

4. The process according to claim 1, characterized in that the nozzle is connected to a mixing head from which a reaction mixture, especially a polyurethane reaction mixture, flows axially into the spray channel, and further components are admixed with this reactive steam through the inlets.

5. The process according to claim 4, characterized in that solid, liquid and/or gaseous components are added to the reactive stream through the inlets.

6. The process according to claim 1, characterized in that the gas channels are arranged in such a way that a radial flow component is impressed on the axial flow of the reaction mixture by injecting the mixing gas in the planes, which radial flow component has one direction in one of the planes and an opposing direction in the following plane, wherein the introduction of the components through the inlets is also considered a plane.

7. The process according to claim 1, characterized in that a mixing gas in injected through a hollow cylinder, which is provided in the interior of the nozzle, tangentially into the nozzle in at least three planes through at least one gas channel each, wherein said nozzle has further inlets for various components in at least two different planes.

8. The process according to claim 7, characterized in that the gas channels are arranged in such a way that a radial flow component is impressed on the axial flow of the reaction mixture by injecting the mixing gas in the planes, and the directions of the radial flow component in one plane is opposed to the direction thereof in the following plane, wherein the inlets for components are also considered to be planes.

9. A device for producing layers and molded parts of a reactive plastic material by a process according to claim 1, characterized in that said nozzle has a spray channel inside that is separated by a wall from a gas space surrounding it, wherein a mixing gas is injected into the spray channel from the gas space into the spray channel in at least two mixing planes through at least one gas channel each.

10. The device according to claim 9, characterized in that the gas channels are arranged in such a way that the direction of flow of the gas stream when entering the spray channel runs outside the center of the spray channel, and this tangential arrangement impresses a radial flow component to the as such axial flow in the spray channel.

11. The device according to claim 9, characterized in that the gas channels and inlets are arranged in such a way that opposing twist directions are impressed on the mixture over the course of the flow in the spray channel, wherein the twist direction in one plane is opposed to that of the following plane.

12. The device according to claim 9, characterized in that the spray channel is connected to a mixing head, and solids, liquids, reactive gases and/or mixing gases are introduced through the inlets into the reactive stream flowing axially from the mixing head, wherein at least one gas channel for mixing gas is provided upstream of these inlets.

13. The device according to claim 9, characterized in that two gas channels are opposed to one another in one plane.

14. A device for producing layers and molded parts of a reactive plastic material by a process according to claim 1, characterized in that the interior of the spray channel has a hollow cylinder, in the center of which a gas distributor is provided through which mixing gas streams are injected tangentially through gas channels leading into the spray channel.

15. The device according to claim 14, characterized in that inlets lead into the spray channel from the outside in at least two different planes, through which inlets reactive components and at least one solid, liquid and/or gaseous additive can be admixed.

16. The device according to claim 14, characterized in that the gas channels are arranged in such a way that the axially flowing reactive components are given a twist, wherein the twist direction in one plane is different from the twist direction of the following plane, which also holds for the planes in which the reactive components and said at least one additive are admixed.

17. The device according to claim 14, characterized in that two gas channels are opposed to one another in one plane.
